(19) United States
(12) Patent Application Publication
(10) Pub. No.: US 2026/0230941 A1
(43) Pub. Date: Aug. 6, 2026

(54) MODULAR MOBILE COMMUNICATIONS SYSTEMS AND METHODS

(71) Applicant: T-Mobile USA, Inc., Bellevue, WA (US)

(72) Inventor: Philip T. Hartman, Overland Park, KS (US)

(21) Appl. No.: 19/044,671

(22) Filed: Feb. 4, 2025

(51) Int. Cl. H04W 36/00; H04W 4/80; H04W 36/14; H04W 76/15

(52) U.S. Cl. CPC H04W 36/00222; H04W 36/144; H04W 76/15; H04W 4/80

(57) ABSTRACT

A modular mobile wireless communication system can include a long-range wireless module and a user interface module that operate as a unitary mobile device while the two modules are physically attached to one another. Upon physical separation, the modules may initiate a short-range communications connection, allowing the long-range wireless module to communicate with a network using long-range communications means and provide a relay of data between the network and the user interface module, allowing placement of the long-range wireless module in an area that facilitates a high-quality network connection while allowing a user to move about in other areas with the interface module.

### BACKGROUND

Wireless communications technologies have improved significantly over recent years, resulting in the proliferation of wireless communications devices (e.g., user devices such as mobile telephones, smartphones, tablets, laptops, etc.) and networks. Modern wireless communications devices may be configured with components that allow them to communicate with a variety of networks and devices. Such communications may be impacted by the physical environment, which may block or hinder the transmission of wireless communications signals.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative wireless communication network environment in which modular mobile communication systems and methods may be implemented, in accordance with examples of the disclosure.

FIG. 2 is a schematic diagram of an illustrative modular mobile communication system, in accordance with examples of the disclosure.

FIG. 3 is a schematic diagram of an illustrative modular mobile communication system, in accordance with examples of the disclosure.

FIG. 4 is a schematic diagram of an illustrative modular mobile communication system, in accordance with examples of the disclosure.

FIG. 5 is a flow diagram of an illustrative process for implementing a modular mobile communication system, in accordance with examples of the disclosure.

FIG. 6 is a schematic diagram of illustrative components in a modular mobile communication system, in accordance with examples of the disclosure.

FIG. 7 is a schematic diagram of illustrative components in a modular mobile communication system, in accordance with examples of the disclosure.

### DETAILED DESCRIPTION

### Overview

This disclosure is directed in part to systems and techniques for improving the performance of wireless communications systems and devices configured to communicate with various types of wireless communications networks and other networks that facilitate wireless communications between computing devices. Such networks include any networks that may facilitate wireless communications services for one or more wireless communications devices. Such networks include networks that support one or more 3GPP standards, including, but not limited to, Long Term Evolution (LTE) networks (e.g., 4G LTE networks), New Radio (NR) networks (e.g., 5G NR networks), and 6G networks. Such networks further include non-terrestrial networks (NTN) that incorporate the use of satellites as network access systems (e.g., base stations), such as 5G NTN and 6G NTN. However, the disclosed systems and techniques may be applicable in any network or system in which a user device may request and receive access to communicate with one or more network and/or remote devices using any protocol.

In examples, the disclosed systems and techniques may enhance the functionality of wireless communications systems and devices by facilitating the positioning of long-range wireless components of a wireless communications device for improved communication connectivity with a wireless network, while allowing the independent movement of the user interface components of the wireless communications device for greater user convenience. In conventional systems, a wireless communications device (e.g., mobile telephone, smartphone, user equipment (UE), wireless user device, wireless communications system, etc.; generally referred to as “UE” herein) includes both components configured to perform network communications (“long-range wireless components”) and components configured to facilitate user input and user output (“user interface components”) integrated into a same housing. This allows such a wireless communications device to wirelessly communicate with a base station (e.g., gNodeB, eNodeB, NodeB, base transceiver station (BTS), etc.) using its long-range wireless components to exchange wireless communications while providing, using its user interface components, to provide wireless communications services to a user, such as voice, text, and data services.

However, the positioning of such a wireless communications device may affect the quality of the communications (e.g., wireless communications signals) exchanged with a wireless communications network. For example, walls, ceilings, and other physical structures and objects may affect the quality of a long-range wireless communications signal. Therefore, such devices may perform better with fewer such interfering objects between the device and a wireless communications network base station. On the other hand, a wireless communications device position that provides an improved wireless communications connectivity with a wireless communications network may not be a position that is convenient or possible for the device user. For instance, a user may wish to operate a wireless communications device indoors, while the walls and ceiling of the structure in which the user is located may negatively affect the wireless communications signals required to provide the user's desired wireless communications services. Accordingly, it may be challenging to simultaneously provide quality service and user convenience using currently available wireless communications devices and systems.

To address these deficiencies of traditional wireless communications technologies, the disclosed modular mobile communications systems and methods include a modular wireless communications device that simultaneously provides for increased quality of wireless communications connectivity and convenience of user positioning. In various examples, a modular wireless communications device may be configured with a long-range wireless communications module that may include one or more components configured to communicate with a wireless communications network. Specifically, the long-range wireless communications module may include one or more components configured to communicate with a wireless network base station, such as a terrestrial or NTN base station (e.g., eNodeB, gNodeB, nodeB, BTS, etc.). The modular wireless communications device may also be configured with a user interface module that may include one or more components configured to accept user input and provide output for user consumption, such as a display, keypad, speakers, haptic (e.g., vibrating) components, etc.

The long-range wireless communications module and the user interface module may both be configured with short-range wireless components, such as wi-fi components and/or Bluetooth components. The long-range wireless communications module and the user interface module may also both be configured with processing and memory components, as well as batteries. Such memory components may include non-transitory computer-readable media configured with instructions that, when executed by the associated processing components configured at the long-range wireless communications module and the user interface module, perform one or more of the operations described herein.

The long-range wireless communications module and the user interface module may be physically attachable such that, when affixed to one another (e.g., detachably affixed), the long-range wireless communications module and the user interface module form a unitary wireless communications device. While physically attached, the long-range wireless communications module and the user interface module may communicate via one or more physical communications connections created at one or more physical attachment points. In this configuration, the wireless communications device may function similarly to traditional wireless communications devices.

The long-range wireless communications module and the user interface module may further be physically detachable such that they may be physically separated. The long-range wireless communications module and the user interface module may be configured to establish one or more short-range wireless communications connections with one another using their respective short-range wireless components. In examples, the long-range wireless communications module and the user interface module may be configured to detect physical detachment from one another. In response to this detection, the long-range wireless communications module and the user interface module may be configured to automatically initiate the establishment of one or more short-range wireless communications connections with each other. In other examples, the long-range wireless communications module and the user interface module may be configured to initiate the establishment of one or more short-range wireless communications connections with each other in response to a user input (e.g., an instruction provided via a user input component, such as a button or a touchscreen) indicating that the user is preparing to physically separate (e.g., detach) the two modules.

Once separated, the long-range wireless communications module may relay long-range wireless communications to the user interface module via the short-range wireless communications connection(s). The long-range wireless communications module may further receive user data from the user interface module via the short-range wireless communications connection(s) and relay such user data to a wireless communications network relay long-range wireless communications. This physical module separation and communication process may allow the user to place the long-range wireless communications module at an area with improved long-range communications signal reception while operating the user interface components of the modular wireless communications device in a convenient location.

Upon reattachment of (e.g., attachably affixing) the long-range wireless communications module to the user interface module, the long-range wireless communications module and the user interface module may resume connectivity via the one or more physical communications connections that may be created at the one or more physical attachment points when the modules are physically attached. The long-range wireless communications module and the user interface module may further terminate or suspend the short-range wireless communications connection(s) that were in use during their detachment. Alternatively, the long-range wireless communications module and the user interface module may maintain the short-range wireless communications connection(s) that were in use during their detachment under particular conditions, for example, when there is a failure to successfully establish communications via the physical attachment points (e.g., due to malfunction, incomplete attachment or seating, etc.).

By providing separable long-range wireless communications and user interface components that facilitate improved wireless network connectivity and increased user convenience, the systems and methods described herein can improve the performance and increase the efficiency of wireless user devices and network resources while improving the user experience by mitigating the effects of poor quality signals due to physical obstructions while allowing user mobility. For example, the methods and systems described herein may be more efficient and/or more robust than conventional systems, as they may increase the efficiency of wireless user devices and network resource utilization by reducing unnecessary (e.g., repeated) signaling on the network and increased power usage by the wireless user device that often results from the noise, interference, and other low-quality channel conditions created by physical obstacles. That is, the methods and systems described herein provide a technological improvement over existing systems and processes by facilitating an improved user experience and increasing device and network efficiency, reducing the use of wireless user device and common resources to work around poor long-range wireless antenna locations. In addition to improving the efficiency of network and device resource utilization, the systems and methods described herein can provide more robust systems by, for example, making more efficient use of network devices and user devices by reducing unnecessary and/or unproductive device and network interactions (e.g., retransmissions), thereby freeing network and user device resources for more productive operations.

Illustrative environments, processes, and techniques for implementing systems and methods for modular mobile communications are described below. However, the described systems and techniques may be implemented in other environments.

### Illustrative System Architecture

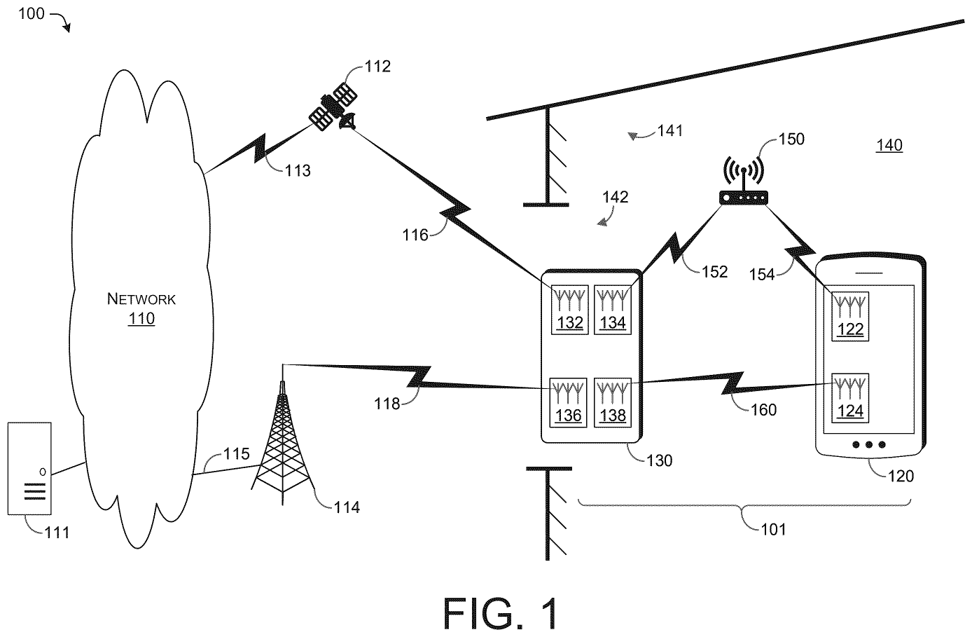

FIG. 1 is a schematic diagram of an illustrative wireless network environment 100 in which the disclosed systems and techniques may be implemented. The environment 100 may include a network 110 that may be a wireless communications network that may facilitate communication between computing devices and/or mobile devices (e.g., modular wireless communications device 101). The network 110 may be any type of wireless communications network and may include any number and type of core and edge network components. Various connections between components and functions in the network 110 may be wired, wireless, or a combination thereof. Various connections between the network 110 and devices that communicate with the network 110 (e.g., via edge components such as base stations) may be wired, wireless, or a combination thereof. The components and functions described herein may be implemented as physical devices, as software components and/or functions executing on one or more computing devices, and as any combination thereof.

In various embodiments, the network 110 may facilitate the establishment of communications sessions for one or more wireless devices, such as the modular wireless communications device 101. In examples, the network 110 may facilitate (e.g., packet-based) communications between such wireless devices and other wireless devices, devices on the Internet, one or more systems and/or devices configured thereon, and/or one or more other (e.g., data, voice, etc.) networks. The modular wireless communications device 101 may be configured to perform functions and operations of any type of wireless device capable of wirelessly interacting with the network 110 (e.g., a smartphone, a cellular telephone, etc.).

In FIG. 1, connections between components may be logical and/or communications connections that may be facilitated by one or more wired and/or wireless connections and may include traversal of one or more devices, components, and/or functions that may or may not be shown in FIG. 1.

The modular wireless communications device 101 may be operating in area 140 that may be, for instance, a building. The area 140 may have various portions 141 that may provide a partial or total physical obstruction for wireless communications signals (e.g., walls, ceiling, etc.). The area 140 may also include an opening 142 that may provide little or no physical obstruction for wireless communications signals (e.g., window, door, etc.).

The area 140 may be in the general vicinity of a base station 114 that may provide access to the network 110 via a physical connection 115. The base station 114 may be any type of base station, such as an eNodeB, a gNodeB, a nodeB, a BTS, etc. The area 140 may also, or instead, be in an area of coverage of an NTN base station 112 (e.g., that may be a satellite or may be configured at a satellite) that may provide access to the network 110 via a wireless connection 113. The NTN base station 112 may be any type of base station or may function as any type of base station, such as an eNodeB, a gNodeB, a nodeB, a BTS, etc.

The modular wireless communications device 101 may include a long-range wireless module 130 and a user interface module 120 that may be configured to be detachably affixed to one another as described herein (shown detached in FIG. 1). In examples, the long-range wireless module 130 may be configured with cellular wireless communications components 136 that may be configured to communicate with the base station 114 via a long-range communications connection 118 that may be, for instance, a 4G, 5G, or 6G communications connection. Alternatively or additionally, the long-range wireless module 130 may be configured with NTN wireless communications components 132 that may be configured to communicate with the NTN base station 112 via an NTN long-range communications connection 116 that may be, for instance, an NTN 5G or NTN 6G communications connection.

The long-range wireless module 130 may further be configured with short-range wireless communications components 138 that may allow direct short-range wireless communications with the user interface module 120. For example, the short-range wireless communications components 138 may include Bluetooth communications components and/or other direct device-to-device wireless communication components. The components 138 may be configured to establish and facilitate direct short-range wireless communications connection 160 with short-range wireless communications components 124 that may be configured at the user interface module 120.

The long-range wireless module 130 may also, or instead, be configured with short-range wireless communications components 134 that may allow indirect short-range wireless communications with the user interface module 120. For example, the short-range wireless communications components 134 may include Wi-Fi communications components and/or other indirect wireless communication components. The components 134 may be configured to establish and facilitate short-range wireless communications connection 152 (e.g., a Wi-Fi connection) with a Wi-Fi router 150. The Wi-Fi router 150 may be any type and number of wireless routers or Wi-Fi communications components that may facilitate relatively short-range wireless communications. The Wi-Fi router 150 may also establish and facilitate short-range wireless communications connection 154 (e.g., a Wi-Fi connection) with short-range wireless communications components 122 that may be configured at the user interface module 120. The connections 152 and 154 may allow the long-range wireless module 130 and the user interface module 120 to communicate via the Wi-Fi router 150.

A user may physically separate the long-range wireless module 130 of the modular wireless communications device 101 from the user interface module 120, for instance, so that the long-range wireless module 130 may be placed proximate to the opening 142 for improved signal reception while the user may operate the user interface module 120 in a portion of the area 140 that is not proximate to the opening 142. In response to detecting this physical separating (e.g., based on detecting a loss of electrical connection between the two modules at one or more physical and/or electrical attachment points), the long-range wireless module 130 and/or the user interface module 120 may initiate the establishment of one or more short-range wireless communications connections.

For example, in response to detecting a loss of physical connectivity to the long-range wireless module 130, the user interface module 120 may perform operations involving the short-range wireless communications components 124 to establish the Bluetooth communications connection 160 with the long-range wireless module 130 (e.g., using the short-range wireless communications components 138 of the long-range wireless module 130). The long-range wireless module 130 may also, or instead, be configured to perform operations involving the short-range wireless communications components 138 to establish the Bluetooth communications connection 160 with the user interface module 120 (e.g., using the short-range wireless communications components 124 of the user interface module 120) in response to detecting a loss of physical connectivity to the long-range wireless module 130.

Using the established Bluetooth communications connection 160, the long-range wireless module 130 may facilitate communications with a remote system, such as a remote system 111, via that network 110. For example, the long-range wireless module 130 may communicate with the remote system 111 via the cellular long-range communications connection 118, the base station 114, and the network 110. Alternatively or additionally, the long-range wireless module 130 may communicate with the remote system 111 via the NTN communications connection 116, the NTN base station 112, and the network 110. The long-range wireless module 130 may provide data received from the remote system 111 using one or more of these means to the user interface module 120 using the Bluetooth communications connection 160.

In various examples, in response to detecting a loss of physical connectivity to the long-range wireless module 130, the user interface module 120 may also, or instead, perform operations involving the short-range wireless communications components 122 to establish the Wi-Fi communications connection 154 with the Wi-Fi router 150. The long-range wireless module 130 may also, or instead, be configured to perform operations involving the short-range wireless communications components 134 to establish the Wi-Fi communications connection 152 with the Wi-Fi router 150 in response to detecting a loss of physical connectivity to the long-range wireless module 130.

Using the established Wi-Fi communications connections 152 and 154, the long-range wireless module 130 may facilitate communications with the remote system 111 via that network 110. For example, the long-range wireless module 130 may communicate with the remote system 111 via the cellular communications connection 118, the base station 114, and the network 110. Alternatively or additionally, the long-range wireless module 130 may communicate with the remote system 111 via the NTN communications connection 116, the NTN base station 112, and the network 110. The long-range wireless module 130 may provide data received from the remote system 111 using one or more of these means to the user interface module 120 using the Wi-Fi communications connections 152 and 154.

In various examples, the long-range wireless module 130 and the user interface module 120 may initiate or otherwise establish short-range communications connections before separation, for instance, to ensure a seamless transition from physical connectivity to wireless connectivity. For example, while physically attached to the long-range wireless module 130, the user interface module 120 may establish the Wi-Fi communications connection 154 using the short-range wireless communications components 122 upon detection of the Wi-Fi router 150. Similarly, while physically attached to the user interface module 120, the long-range wireless module 130 may establish the Wi-Fi communications connection 152 using the short-range wireless communications components 122 upon detection of the Wi-Fi router 150. In this way, the modules will be prepared to seamlessly transition to wireless interconnectivity from physical interconnectivity, thereby reducing disruption to the user experience.

Similarly, while physically attached, the long-range wireless module 130 and the user interface module 120 may interact to the establish the Bluetooth communications connection 160, which may also facilitate a seamless transition to wireless interconnectivity from physical interconnectivity when the modules are ultimately separated, thereby reducing disruption to the user experience.

When reattached to one another, the long-range wireless module 130 and the user interface module 120 may terminate one or more established short-range wireless communications connections. For example, the modules may terminate one or more of the Bluetooth communications connection 160, the Wi-Fi communications connection 152, and the Wi-Fi communications connection 154 upon detection of physical reattachment (e.g., detection of physical and/or electrical connectivity). Alternatively, the user interface module may maintain the Wi-Fi communications connection 154 upon detection of physical reattachment as that connection may be used to access one or more systems via a local network to which the Wi-Fi router 150 may be communicatively connected.

By facilitating the use of the NTN long-range communications connection 116 and/or the cellular long-range communications connection 118 by the long-range wireless module 130 proximate to a low-interference portion of the area 140, such as the opening 142, while allowing the use of the user interface module 120 in other portions of the area 140, the disclosed systems and methods avoid wasting network and device resources due repeating operations and signals due to interference, noise, and low-quality channel conditions. For example, the modular wireless communications device 101 may avoid wasting resources on retransmissions and error handling due to a wireless communications component performing poorly according to the disclosed systems and techniques.

### Illustrative Modular Wireless Communications Systems

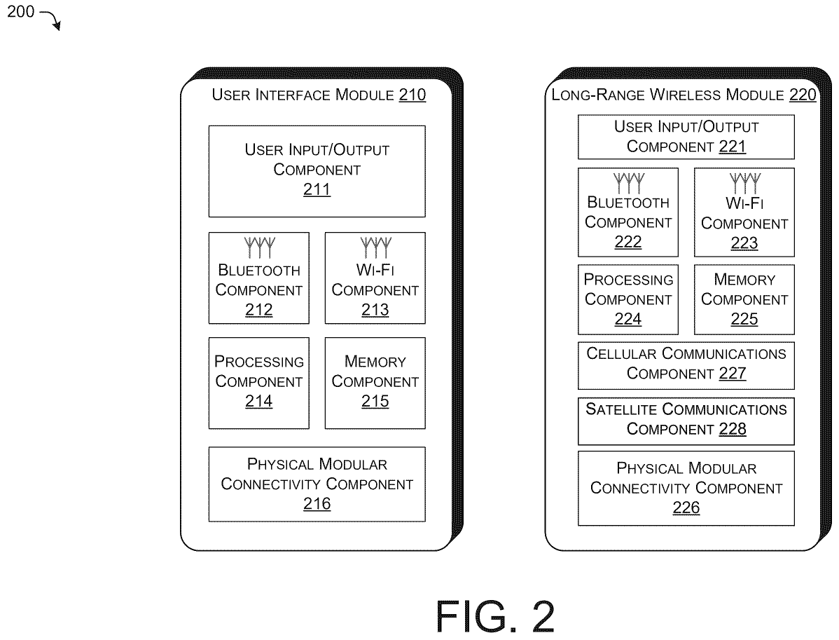

FIG. 2 is an example of a modular wireless communications system 200 for use with the systems and methods disclosed herein, and in accordance with some examples of the present disclosure. The modular wireless communications system 200 may include a user interface module 210 and a long-range wireless module 220. The modular wireless communications system 200, including the modules 210 and 220, may be configured to perform the operations and functions associated with corresponding systems and modules as described herein.

The user interface module 210 may include a user input/output component 211 that may include one or more of a touchscreen, a speaker, a haptic device, a button, a display, a microphone, and/or any other device or component that may be used to collect user input and/or to generate and/or present output for user consumption.

The user interface module 210 may include one or more components that may be configured to perform short-range wireless communications operations. For example, the user interface module 210 may include a Bluetooth component 212 that may be configured with one or more antennas, processors, memory, etc., that may be configured to establish and operate one or more Bluetooth communications sessions. The user interface module 210 may also, or instead, include a Wi-Fi component 213 that may be configured with one or more antennas, processors, memory, etc., that may be configured to establish and operate one or more Wi-Fi communications sessions.

The user interface module 210 may further include a processing component 214 that may include one or more processors of any type that may be configured to execute instructions to perform the various operations described herein. The user interface module 210 may further include a memory component 215 that may include one or more data storage devices of any type that may be configured to store instructions that may be executed by the processing component 214 and other data that may be used to perform the various operations described herein.

The user interface module 210 may further include a physical modular connectivity component 216 that may be configured to accept a physical connection with another module, such as the long-range wireless module 220. For instance, the physical modular connectivity component 216 may include one or more physical elements configured to fixedly attach to one or more physical elements of a physical modular connectivity component 226 of the long-range wireless module 220. The physical modular connectivity component 216 may also, or instead, include one or more electrical elements configured to form an electrical connection via a physical attachment with one or more physical elements of the physical modular connectivity component 226 of the long-range wireless module 220.

The processing component 214 may be communicatively connected to the physical modular connectivity component 216 such that the processing component 214 may detect that the physical modular connectivity component 216 has physically and/or electrically engaged or disengaged with the physical modular connectivity component 226 of the long-range wireless module 220. In response to such a detection, the processing component 214 may execute one or more of the operations described herein to facilitate and/or terminate short-range communications with the long-range wireless module 220.

The long-range wireless module 220 may include a user input/output component 221 that may include one or more of a touchscreen, a speaker, a haptic device, a button, a display, a microphone, a light, and/or any other device or component that may be used to collect user input and/or to generate and/or present output for user consumption. Alternatively, the long-range wireless module 220 may not include a user input/output component and may operate based on instructions stored in memory and/or through input/output received via the user interface module 210.

The long-range wireless module 220 may include one or more components that may be configured to perform short-range wireless communications operations. For example, the long-range wireless module 220 may include a Bluetooth component 222 that may be configured with one or more antennas, processors, memory, etc., that may be configured to establish and operate one or more Bluetooth communications sessions. The long-range wireless module 220 may also, or instead, include a Wi-Fi component 223 that may be configured with one or more antennas, processors, memory, etc., that may be configured to establish and operate one or more Wi-Fi communications sessions.

The long-range wireless module 220 may further include a processing component 224 that may include one or more processors of any type that may be configured to execute instructions to perform the various operations described herein. The long-range wireless module 220 may further include a memory component 225 that may include one or more data storage devices of any type that may be configured to store instructions that may be executed by the processing component 224 and other data that may be used to perform the various operations described herein.

The long-range wireless module 220 may include one or more components that may be configured to perform long-range wireless communications operations. For example, the long-range wireless module 220 may include a cellular communications component 227 that may be configured with one or more antennas, processors, memory, etc., that may be configured to establish and operate one or more cellular wireless communications sessions of any type, such as 4G, 5G, and 6G, communications sessions. The long-range wireless module 220 may also, or instead, include a satellite communications component 228 that may be configured with one or more antennas, processors, memory, etc., that may be configured to establish and operate one or more satellite communications sessions of any type, such as any type of NTN communications session.

As noted above, the long-range wireless module 220 may include the physical modular connectivity component 226 that may be configured to accept a physical connection with another module, such as the user interface model 210. Like the physical modular connectivity component 216, the physical modular connectivity component 226 may include one or more physical elements configured to fixedly attach to one or more physical elements of a physical modular connectivity component 216 of the user interface model 210. The physical modular connectivity component 226 may also, or instead, include one or more electrical elements configured to form an electrical connection via a physical attachment with one or more physical elements of the physical modular connectivity component 216 of the user interface model 210.

The processing component 224 may be communicatively connected to the physical modular connectivity component 226 such that the processing component 224 may detect that the physical modular connectivity component 226 has physically and/or electrically engaged or disengaged with the physical modular connectivity component 216 of the user interface model 210. In response to such a detection, the processing component 224 may execute one or more of the operations described herein to facilitate and/or terminate short-range communications with the user interface model 210.

In examples, the long-range wireless module 220 may be further encased or otherwise configured with weather-resistant components that may allow safer exposure of this module to the elements. This may allow a user to place the module proximate to the outdoors to allow for improved signal reception even in poor weather.

Note that each of the modules 210 and 220 may have other components that are not shown here. For instance, each component may be configured with its own power source (e.g., battery) and means of charging such a power source (e.g., power supply access, electrical connections, etc.).

The physical connectivity components 216 and 226 may take any form and number. For instance, there may be several attachment points about the circumference of each module that may be manually affixed to the corresponding attachment points on the other module. Each such attachment point may be any suitable means of mechanical and/or physical attachment (e.g., clasp, clip, etc.). One or more of these attachment points may also include an electrical connection that may be used for communicative connectivity between the modules when they are physically attached. Such electrical connections may also facilitate power exchange between the modules and any other cross-module electrical function.

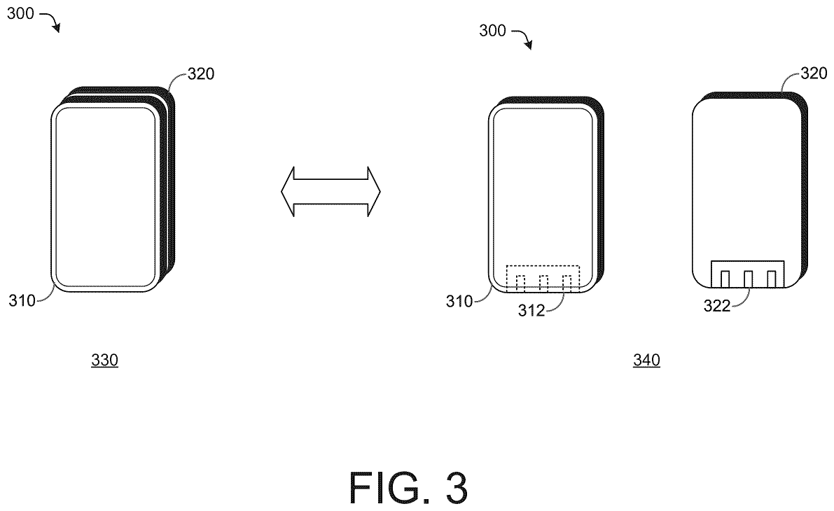

FIG. 3 is an example of a modular wireless communications system 300 for use with the systems and methods disclosed herein, and in accordance with some examples of the present disclosure. The modular wireless communications system 300 may include a user interface module 310 and a long-range wireless module 320. The modular wireless communications system 300, including the modules 310 and 320, may be configured to perform the operations and functions associated with corresponding systems and modules as described herein.

As shown in this example, the user interface module 310 and the long-range wireless module 320 may be of substantially similar size and shape. When attached to one another, as shown in configuration 330, the user interface module 310 and the long-range wireless module 320 may form a single, unified wireless communications device that may be of similar size and shape to a conventional (e.g., non-modular) wireless communications device.

Configuration 340 illustrates the user interface module 310 and the long-range wireless module 320 physically uncoupled. In this configuration, the physical modular connectivity component 312 of the user interface module 310 is shown (e.g., configured on the back of the user interface module 310), and the physical modular connectivity component 322 of the long-range wireless module 320 is shown (e.g., configured on the front of the long-range wireless module 320). The physical modular connectivity components 312 and 322 may include physical and/or electrical attachment points that may be manipulated to connect and/or separate the modules 310 and 320.

Note that either or both of the user interface module 310 and the long-range wireless module 320 may be further encased or otherwise configured with weather-resistant components that may allow safer exposure of this module to the elements. This may be especially helpful for the long-range wireless module 320 that may be positioned outdoors or proximate to the elements to improve signal reception.

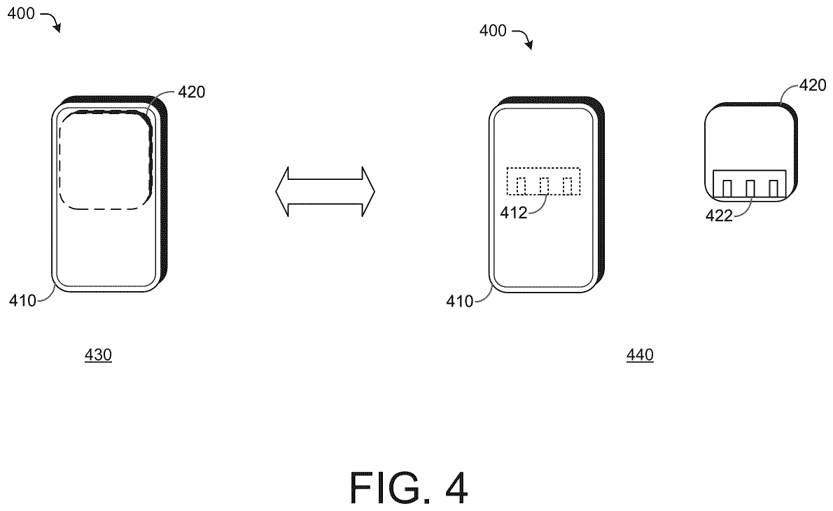

FIG. 4 is an example of another modular wireless communications system 400 for use with the systems and methods disclosed herein, and in accordance with some examples of the present disclosure. The modular wireless communications system 400 may include a user interface module 410 and a long-range wireless module 420. The modular wireless communications system 400, including the modules 410 and 420, may be configured to perform the operations and functions associated with corresponding systems and modules as described herein.

As shown in this example, the user interface module 410 and the long-range wireless module 420 may be of a substantially different size and/or shape. In this example, the long-range wireless module 420 may fit within or otherwise be a smaller module that may be at least partially obscured by the user interface module 410. This may increase the portability of the modular wireless communications system 400 and the flexibility of positioning the long-range wireless module 420.

When attached to one another, as shown in configuration 430, the user interface module 410 and the long-range wireless module 420 may form a single, unified wireless communications device that may be of similar size and shape to a conventional (e.g., non-modular) wireless communications device.

Configuration 440 illustrates the user interface module 410 and the long-range wireless module 420 physically uncoupled. In this configuration, the physical modular connectivity component 412 of the user interface module 410 is shown (e.g., configured on the back of the user interface module 410), and the physical modular connectivity component 422 of the long-range wireless module 420 is shown (e.g., configured on the front of the long-range wireless module 420). The physical modular connectivity components 412 and 422 may include physical and/or electrical attachment points that may be manipulated to connect and/or separate the modules 410 and 420.

Note that either or both of the user interface module 410 and the long-range wireless module 420 may be further encased or otherwise configured with weather-resistant components that may allow safer exposure of this module to the elements. This may be especially helpful for the long-range wireless module 420 that may be positioned out-of-doors or proximate to the elements to improve signal reception.

### Illustrative Operations

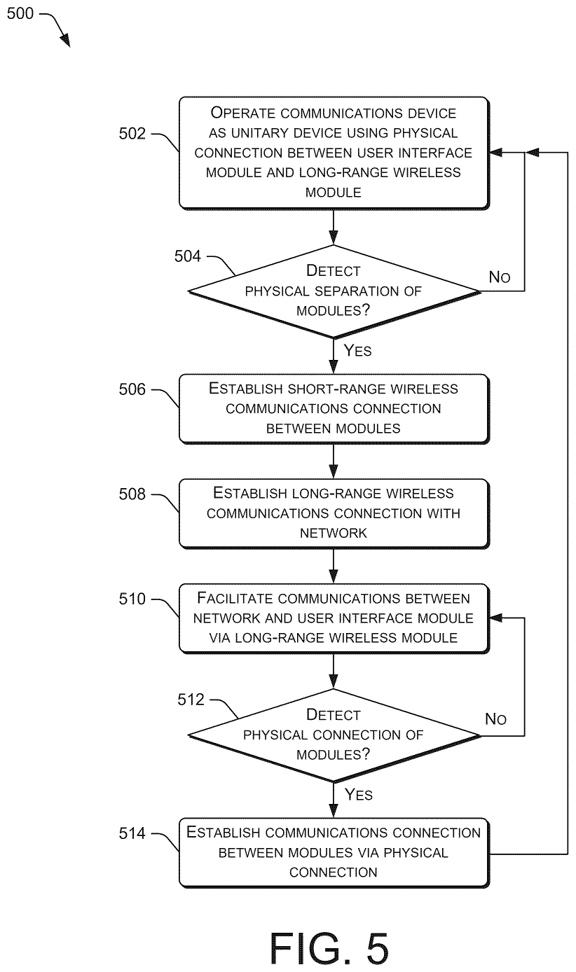

FIG. 5 shows a flow diagram of an illustrative process 500 for operating a modular mobile communications system according to the disclosed embodiments. The process 500 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 500 may be described with reference to the wireless network environment 100 and/or the modular wireless communications device 101 of FIG. 1, and/or the modular wireless communications system 200 of FIG. 2; however, other environments and systems may also be used.

At block 502, a communications device configured with a long-range wireless module and a user interface module (e.g., modular wireless communications device 101, modular wireless communications system 200) may operate as a unitary device. That it, the long-range wireless module and the user interface module may be physically and electronically connected and may not require short-range wireless communications to interact. Note, however, that a communications device may establish short-range communications between the modules even though the modules are physically connected. Such short-range communications may serve as a backup interaction means in the event of a connectivity failure and/or may be maintained and/or created in preparation for a potential separation of the modules.

At block 504, the communications device may determine whether a physical separation of the long-range wireless module and the user interface module has been detected. If not, the device may continue to operate as a unitary device at block 502.

If, at block 504, the communications device detects a physical separation of the long-range wireless module and the user interface module, at block 506, the communications device may establish one or more short-range communications connections between the long-range wireless module and the user interface module. As described herein, this may include establishing a Bluetooth communications session between the long-range wireless module and the user interface module. Alternatively or additionally, this may include each of the long-range wireless module and the user interface module establishing a Wi-Fi communications session that may then be used to communicate with one another. The long-range wireless module and the user interface module may each be configured with instructions stored in a memory that are responsively executed by a processor configured at each module to establish the short-range communications connection(s).

In other examples, the short-range communications connection(s) may have been established prior to the physical separation of the modules, for instance, based on a default configuration and/or in response to user input. For instance, the physical separation of the two modules may be achieved by pressing a button that may also serve as an input that triggers the establishment of one or more short-range communications connections.

At block 508, the communications device, and in particular, the long-range wireless module, may establish one or more long-range communications connections with a network base station. As described herein, this may include establishing a cellular wireless communications connection and/or an NTN wireless communications connection. Note that, in some examples, such a communications connection may be established by the long-range wireless module in response to detection of separation of the long-range wireless module from the user interface modules, while in other examples, the long-range wireless module may have previously established such a long-range communications connection. For example, while operating as a unitary communications device at 502, the long-range wireless module may have established a connection to a network using long-range wireless communications. In such examples, the device may continue to use this connection at block 508.

At block 510, the long-range wireless module may facilitate communications between the network and the user interface module using the short-range wireless communications connection(s) established at block 506. For instance, the long-range wireless module may receive data from the network via the long-range communication connection(s) established at block 508 (or earlier) and forward such data to the user interface module via the short-range wireless communications connection(s) established at block 506. Similarly, the long-range wireless module may receive data from the user interface module via the short-range wireless communications connection(s) established at block 506 and forward that data to the network via the long-range communication connection(s) established at block 508 (or earlier).

The device may detect a physical and/or electrical connection between the long-range wireless module and the user interface module at block 512. If no such connection is detected, the process 500 may remain at block 510 operating as a modular device with physically disconnected, but wirelessly communicatively connected, long-range wireless module and the user interface module.

If, at block 512, the device detects a physical and/or electrical connection between the long-range wireless module and the user interface module, the process may move to block 514, where communication between the modules may be reestablished using the reestablished physical and/or electrical connection. For example, one or both of the long-range wireless module and the user interface module may be configured to detect a physical connection with the counterpart module based on detecting an electrical signal on the physical and/or electrical attachment points of that module. In response to this detection, one or both of the long-range wireless module and the user interface module may also terminate the short-range wireless communications connection with the counterpart module. In examples, one or both of the long-range wireless module and the user interface module may maintain one or more short-range wireless communications connections that may be of use for purposes other than inter-module communication, such as a Wi-Fi communications connection used to connect to a local network.

Once unitary operation is reestablished at block 514, the process 500 may return to block 502 to operate the communications device as a unitary device.

### Example User Equipment

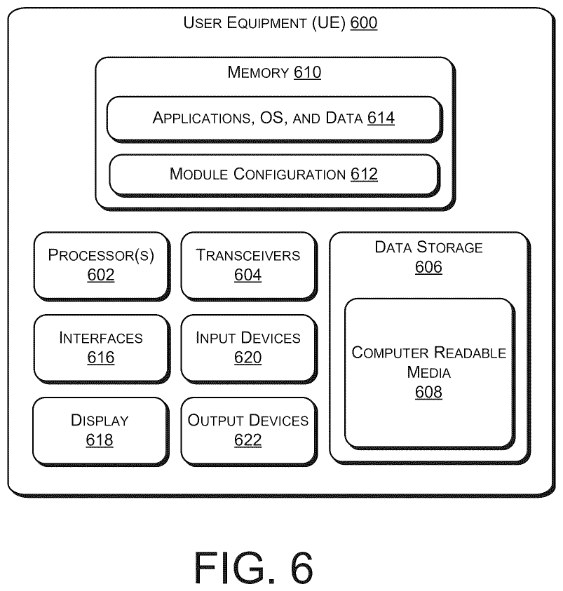

FIG. 6 is an example of a UE 600, which may be any type of UE, such as the modular wireless communications device 101 of FIG. 1 and the modular wireless communications system 200 of FIG. 2, for use with the systems and methods disclosed herein, in accordance with some examples of the present disclosure. The UE 600 may include one or more processors 602, one or more transmit/receive antennas (e.g., transceivers or transceiver antennas) 604, and a data storage 606. The data storage 606 may include a computer-readable media 608 in the form of memory and/or cache. This computer-readable media may include a non-transitory computer-readable media. The processor(s) 602 may be configured to execute instructions, which can be stored in the computer-readable media 608 and/or in other computer-readable media accessible to the processor(s) 602. In some configurations, the processor(s) 602 is a Central Processing Unit (CPU), a Graphics Processing Unit (GPU), or both CPU and GPU, or any other sort of processing unit. The transceiver antenna(s) 604 can exchange signals with a base station, such as base station 112 and base station 114 of FIG. 1.

The UE 600 may be configured with a memory 610. The memory 610 may be implemented within, or separate from, the data storage 606 and/or the computer-readable media 608. The memory 610 may include any available physical media accessible by a computing device to implement the instructions stored thereon. For example, the memory 610 may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which may be used to store the desired information and which may be accessed by the UE 600.

The memory 610 can store several modules, such as instructions, data stores, and so forth that are configured to execute on the processor(s) 602. In configurations, the memory 610 may also store one or more applications 614 configured to receive and/or provide voice, data, and messages (e.g., SMS messages, Multi-Media Message Service (MMS) messages, Instant Messaging (IM) messages, Enhanced Message Service (EMS) messages, one or more dialers and related components, etc.) to and/or from another device or component (e.g., the base station 112 and base station 114 of FIG. 1). The applications 614 may also include one or more operating systems and/or one or more third-party applications that provide additional functionality to the UE 600. The memory 610 may also include module-related components, such as the module configuration component 612 that may be configured to perform any of the module-related operations described herein (e.g., the automatic establishment of communications session(s), automatic termination of communications session(s), detection of physical and/or electrical connection/disconnection, etc.). The memory may also, or instead, store bandwidth information, such as UE-supported bands, bandwidth(s), and bandwidth parts, one or more IP addresses, indications of sets of IP addresses, as well as communications session information such as UE-specific carrier bandwidth(s). The memory may also, or instead, antenna configuration information, session management component information, user plane component information, policy component information, etc.

Although not all illustrated in FIG. 6, the UE 600 may also comprise various other components, e.g., a battery, a charging unit, one or more network interfaces 616, an audio interface, a display 618, a keypad or keyboard, and one or more input devices 620, and one or more output devices 622.

### Example Computing Device

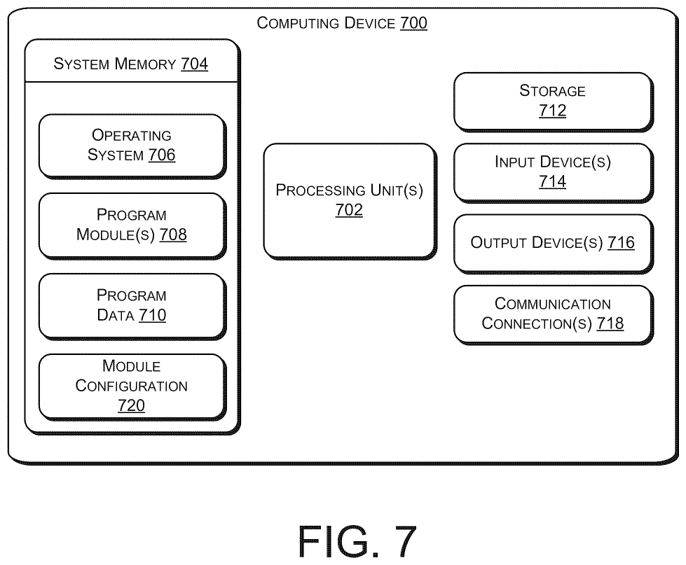

FIG. 7 is an example of a computing device 700 for use with the systems and methods disclosed herein, in accordance with some examples of the present disclosure. The computing device 700 can be used to implement various components of a mobile wireless device (e.g., modular wireless communications device 101 of FIG. 1, modular wireless communications system 200 of FIG. 2) a core network, a base station (e.g., base station 112, base station 114 of FIG. 1), and/or any servers, routers, gateways, gateway elements, administrative components, network components, etc. that can be used by a communication provider.

In various embodiments, the computing device 700 can include one or more processing units 702 and system memory 704. Depending on the exact configuration and type of computing device, the system memory 704 can be volatile (such as RAM), non-volatile (such as ROM, flash memory, etc.) or some combination of the two. The system memory 704 can include an operating system 706, one or more program modules 708 (e.g., channel quality determination component(s) and/or module(s), UE configuration component(s) and/or module(s), base station configuration component(s) and/or module(s)), program data 710, and module configuration data 720. The system memory 704 may be secure storage or at least a portion of the system memory 704 can include secure storage. The secure storage can prevent unauthorized access to data stored in the secure storage. For example, data stored in the secure storage can be encrypted or accessed via a security key and/or password.

The computing device 700 can also include additional data storage devices (removable and/or non-removable) such as, for example, magnetic disks, optical disks, or tape. Such additional storage is illustrated in FIG. 7 by storage 712.

The computing device 700 may store, in either or both of the system memory 704 and the storage 712, module configuration data, module executable program data, antenna information, antenna configuration information, UE information, location information, IP addresses, IP address data, timer information and/or timestamps, message transfer data, session management data, etc.

Non-transitory computer storage media of the computing device 700 can include volatile and nonvolatile, removable and non-removable media implemented in any method or technology for storage of information, such as computer-readable instructions, data structures, program modules, or other data. The system memory 704 and storage 712 are examples of computer-readable storage media. Non-transitory computer-readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by computing device 700. Any such non-transitory computer-readable storage media can be part of the computing device 700.

In various embodiments, any or all of the system memory 704 and storage 712 can store programming instructions which, when executed, implement some or all of the functionality described above as being implemented by one or more systems configured in the environment 100, components of the network 110, modular wireless communications device 101 of FIG. 1, and/or modular wireless communications system 200 of FIG. 2, among other examples.

The computing device 700 can also have one or more input devices 714 such as a keyboard, a mouse, a touch-sensitive display, voice input device, etc. The computing device 700 can also have one or more output devices 716 such as a display, speakers, a printer, etc. can also be included. The computing device 700 can also contain one or more communication connections 718 that allow the device to communicate with other computing devices using wired and/or wireless communications.

### Example Clauses

The following paragraphs describe various examples. Any of the examples in this section may be used with any other of the examples in this section and/or any of the other examples or embodiments described herein.

A: A wireless communications device, comprising a user interface module comprising a first processor, a first non-transitory computer-readable media, a user input/output component, and a first short-range wireless communications component; and a long-range wireless communications module detachably affixed to the user interface module, the long-range wireless communications module comprising a second processor, a second non-transitory computer-readable media, a second short-range wireless communications component, and a long-range wireless communications component; wherein the second non-transitory computer-readable media comprises computer-executable instructions that, when executed by the second processor, cause the second processor to perform operations comprising in response to detecting a physical detachment of the long-range wireless communications module from the user interface module, controlling the second short-range wireless communications component to establish a short-range wireless communications connection with the first short-range wireless communications component, receiving user data at the long-range wireless communications component, and transmitting the user data to the first short-range wireless communications component via the short-range wireless communications connection.

B: The wireless communications device of paragraph A, wherein receiving the user data at the long-range wireless communications component comprises receiving the user data from a non-terrestrial base station.

C: The wireless communications device of paragraph A or B, wherein the short-range wireless communications connection comprises a Bluetooth communications session established between the first short-range wireless communications component and the second short-range wireless communications component.

D: The wireless communications device of any of paragraphs A-C, wherein the short-range wireless communications connection comprises a first Wi-Fi communications session established between the second short-range wireless communications component and a Wi-Fi communications component.

E: The wireless communications device of paragraph C, wherein transmitting the user data to the first short-range wireless communications component via the short-range wireless communications connection comprises transmitting the user data to the Wi-Fi communications component via the first Wi-Fi communications session for transmission, by the Wi-Fi communications component, to the first short-range wireless communications component via a second Wi-Fi communications session established between the first short-range wireless communications component and the Wi-Fi communications component.

F: The wireless communications device of any of paragraphs A-E, wherein the long-range wireless communications module detects the physical detachment of the long-range wireless communications module from the user interface module based at least in part on detecting a loss of electrical connection between the long-range wireless communications module and the user interface module.

G: The wireless communications device of any of paragraphs A-F, wherein receiving the user data at the long-range wireless communications component comprises receiving the user data from an eNodeB or a gNodeB.

H: A method performed by a wireless communications device, the method comprising detecting, at a processor configured at a long-range wireless communications module of the wireless communications device, a physical detachment of the long-range wireless communications module from a user interface module of the wireless communications device; in response to detecting the physical detachment, controlling, by the processor configured at the long-range wireless communications module, a first short-range wireless communications component of the long-range wireless communications module to establish a short-range wireless communications connection with a second short-range wireless communications component of the user interface module; receiving, at a long-range wireless communications component of the long-range wireless communications module, user data; and transmitting, from the first short-range wireless communications component of the long-range wireless communications module, the user data to the second short-range wireless communications component of the user interface module via the short-range wireless communications connection.

I: The method of paragraph H, wherein receiving the user data comprises receiving the user data via one of a 4G communications connection, a 5G communications connection, or a 6G communications connection.

J: The method of paragraph H or I, wherein receiving the user data comprises receiving the user data from a non-terrestrial base station.

K: The method of any of paragraphs H-J, wherein the short-range wireless communications connection comprises a Bluetooth communications session established between the first short-range wireless communications component and the second short-range wireless communications component.

L: The method of paragraphs H-K, wherein the short-range wireless communications connection comprises a first Wi-Fi communications session established between the first short-range wireless communications component and a Wi-Fi communications component.

M: The method of paragraph L, wherein transmitting the user data to the second short-range wireless communications component via the short-range wireless communications connection comprises transmitting the user data to the Wi-Fi communications component via the first Wi-Fi communications session for transmission, by the Wi-Fi communications component, to the second short-range wireless communications component via a second Wi-Fi communications session established between the second short-range wireless communications component and the Wi-Fi communications component.

N: The method of any of paragraphs H-M, further comprising detecting, at the processor configured at the long-range wireless communications module, a physical attachment of the long-range wireless communications module to the user interface module; and in response to detecting the physical attachment, terminating the short-range wireless communications connection with the second short-range wireless communications component; and establishing, by the processor configured at the long-range wireless communications module, a communications connection with the user interface module via a physical attachment point between the long-range wireless communications module and the user interface module.

O: A non-transitory computer-readable media storing computer-executable instructions that, when executed by one or more processors configured at a wireless communications device, cause the one or more processors to perform operations comprising detecting, at a long-range wireless communications module of the wireless communications device, a physical detachment of the long-range wireless communications module from a user interface module of the wireless communications device; in response to detecting the physical detachment, establishing, at the long-range wireless communications module, a short-range wireless communications connection between a first short-range wireless communications component of the long-range wireless communications module and a second short-range wireless communications component of the user interface module; receiving, at a long-range wireless communications component of the long-range wireless communications module, user data; and transmitting, from the first short-range wireless communications component of the long-range wireless communications module, the user data to the second short-range wireless communications component of the user interface module via the short-range wireless communications connection.

P: The non-transitory computer-readable media of paragraph O, wherein the operations further comprise detecting, at the long-range wireless communications module, a physical attachment of the long-range wireless communications module to the user interface module; and in response to detecting the physical attachment terminating the short-range wireless communications connection with the second short-range wireless communications component; and establishing, by the long-range wireless communications module, a communications connection with the user interface module via a physical communications connection between the long-range wireless communications module and the user interface module.

Q: The non-transitory computer-readable media of paragraph P, wherein detecting the physical attachment of the long-range wireless communications module to the user interface module comprises detecting an electrical signal at the physical communications connection.

R: The non-transitory computer-readable media of any of paragraphs O-Q, wherein receiving the user data comprises receiving the user data from a non-terrestrial base station.

S: The non-transitory computer-readable media of any of paragraphs O-R, wherein receiving the user data comprises receiving the user data via one of a 4G communications connection, a 5G communications connection, or a 6G communications connection.

T: The non-transitory computer-readable media of any of paragraphs O-S, wherein the long-range wireless communications module detects the detachment of the long-range wireless communications module from the user interface module based at least in part on detecting a loss of electrical connection between the long-range wireless communications module and the user interface module.

While the example clauses described above are described with respect to one particular implementation, it should be understood that, in the context of this document, the content of the example clauses can also be implemented via a method, device, system, computer-readable medium, and/or another implementation. Additionally, any of the examples A-T can be implemented alone or in combination with any other one or more of the examples A-T.

### Conclusion

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), 6G, Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

Depending on the embodiment, certain operations, acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, components, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and components described in connection with the embodiments disclosed herein can be implemented or performed by a machine, such as a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Unless otherwise explicitly stated, articles such as “a” or “the” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes that come within the meaning and range of equivalency of the claims are to be embraced within their scope.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A wireless communications device, comprising:
a user interface module comprising:
a first processor,
a first non-transitory computer-readable media,
a user input/output component, and
a first short-range wireless communications component; and
a long-range wireless communications module detachably affixed to the user interface module, the long-range wireless communications module comprising:
a second processor,
a second non-transitory computer-readable media,
a second short-range wireless communications component, and
a long-range wireless communications component;
wherein the second non-transitory computer-readable media comprises computer-executable instructions that, when executed by the second processor, cause the second processor to perform operations comprising:
in response to detecting a physical detachment of the long-range wireless communications module from the user interface module, controlling the second short-range wireless communications component to establish a short-range wireless communications connection with the first short-range wireless communications component,
receiving user data at the long-range wireless communications component, and
transmitting the user data to the first short-range wireless communications component via the short-range wireless communications connection.

2. The wireless communications device of claim 1, wherein receiving the user data at the long-range wireless communications component comprises receiving the user data from a non-terrestrial base station.

3. The wireless communications device of claim 1, wherein the short-range wireless communications connection comprises a Bluetooth communications session established between the first short-range wireless communications component and the second short-range wireless communications component.

4. The wireless communications device of claim 1, wherein the short-range wireless communications connection comprises a first Wi-Fi communications session established between the second short-range wireless communications component and a Wi-Fi communications component.

5. The wireless communications device of claim 4, wherein transmitting the user data to the first short-range wireless communications component via the short-range wireless communications connection comprises transmitting the user data to the Wi-Fi communications component via the first Wi-Fi communications session for transmission, by the Wi-Fi communications component, to the first short-range wireless communications component via a second Wi-Fi communications session established between the first short-range wireless communications component and the Wi-Fi communications component.

6. The wireless communications device of claim 1, wherein the long-range wireless communications module detects the physical detachment of the long-range wireless communications module from the user interface module based at least in part on detecting a loss of electrical connection between the long-range wireless communications module and the user interface module.

7. The wireless communications device of claim 1, wherein receiving the user data at the long-range wireless communications component comprises receiving the user data from an eNodeB or a gNodeB.

8. A method performed by a wireless communications device, the method comprising:
detecting, at a processor configured at a long-range wireless communications module of the wireless communications device, a physical detachment of the long-range wireless communications module from a user interface module of the wireless communications device;
in response to detecting the physical detachment, controlling, by the processor configured at the long-range wireless communications module, a first short-range wireless communications component of the long-range wireless communications module to establish a short-range wireless communications connection with a second short-range wireless communications component of the user interface module;
receiving, at a long-range wireless communications component of the long-range wireless communications module, user data; and
transmitting, from the first short-range wireless communications component of the long-range wireless communications module, the user data to the second short-range wireless communications component of the user interface module via the short-range wireless communications connection.

9. The method of claim 8, wherein receiving the user data comprises receiving the user data via one of a 4G communications connection, a 5G communications connection, or a 6G communications connection.

10. The method of claim 8, wherein receiving the user data comprises receiving the user data from a non-terrestrial base station.

11. The method of claim 8, wherein the short-range wireless communications connection comprises a Bluetooth communications session established between the first short-range wireless communications component and the second short-range wireless communications component.

12. The method of claim 8, wherein the short-range wireless communications connection comprises a first Wi-Fi communications session established between the first short-range wireless communications component and a Wi-Fi communications component.

13. The method of claim 12, wherein transmitting the user data to the second short-range wireless communications component via the short-range wireless communications connection comprises transmitting the user data to the Wi-Fi communications component via the first Wi-Fi communications session for transmission, by the Wi-Fi communications component, to the second short-range wireless communications component via a second Wi-Fi communications session established between the second short-range wireless communications component and the Wi-Fi communications component.

14. The method of claim 8, further comprising:
detecting, at the processor configured at the long-range wireless communications module, a physical attachment of the long-range wireless communications module to the user interface module; and
in response to detecting the physical attachment:
terminating the short-range wireless communications connection with the second short-range wireless communications component; and
establishing, by the processor configured at the long-range wireless communications module, a communications connection with the user interface module via a physical attachment point between the long-range wireless communications module and the user interface module.

15. A non-transitory computer-readable media storing computer-executable instructions that, when executed by one or more processors configured at a wireless communications device, cause the one or more processors to perform operations comprising:
detecting, at a long-range wireless communications module of the wireless communications device, a physical detachment of the long-range wireless communications module from a user interface module of the wireless communications device;
in response to detecting the physical detachment, establishing, at the long-range wireless communications module, a short-range wireless communications connection between a first short-range wireless communications component of the long-range wireless communications module and a second short-range wireless communications component of the user interface module;
receiving, at a long-range wireless communications component of the long-range wireless communications module, user data; and
transmitting, from the first short-range wireless communications component of the long-range wireless communications module, the user data to the second short-range wireless communications component of the user interface module via the short-range wireless communications connection.

16. The non-transitory computer-readable media of claim 15, wherein the operations further comprise:
detecting, at the long-range wireless communications module, a physical attachment of the long-range wireless communications module to the user interface module; and
in response to detecting the physical attachment:
terminating the short-range wireless communications connection with the second short-range wireless communications component; and
establishing, by the long-range wireless communications module, a communications connection with the user interface module via a physical communications connection between the long-range wireless communications module and the user interface module.

17. The non-transitory computer-readable media of claim 16, wherein detecting the physical attachment of the long-range wireless communications module to the user interface module comprises detecting an electrical signal at the physical communications connection.

18. The non-transitory computer-readable media of claim 15, wherein receiving the user data comprises receiving the user data from a non-terrestrial base station.

19. The non-transitory computer-readable media of claim 15, wherein receiving the user data comprises receiving the user data via one of a 4G communications connection, a 5G communications connection, or a 6G communications connection.

20. The non-transitory computer-readable media of claim 15, wherein the long-range wireless communications module detects the physical detachment of the long-range wireless communications module from the user interface module based at least in part on detecting a loss of electrical connection between the long-range wireless communications module and the user interface module.
